(19) United States
(12) Patent Application Publication
(10) Pub. No.: US 2008/0216409 A1
(43) Pub. Date: Sep. 11, 2008

(54) Drive device

(75) Inventors: Marian Bochen, Eitelborn (DE); Rolf Mintgen, Thuer (DE); Christian Schindlatz, Sinzig (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 11/985,216

(22) Filed: Nov. 14, 2007

(30) Foreign Application Priority Data
Nov. 15, 2006 (DE) 10 2006 053 730.0

(51) Int. Cl. E05F 15/12

(52) U.S. Cl. 49/340

(57) ABSTRACT

A drive device for a motor vehicle, including a first fastening element connectable to one of a stationary component and a movable component of the motor vehicle; a housing tube comprising a first end facing away from the first fastening element, and a second fastening element on the first end, the second fastening element being connectable to the other of a stationary component and a movable component of the motor vehicle; a spindle drive comprising a threaded spindle; and a spindle nut mounted on the threaded spindle; and an electric motor for driving the threaded spindle in rotation. The spindle drive is configured to move the first fastening element and the housing tube away from each other in an axial movement. When energized the electric motor drives the threaded spindle in rotation with a torque which decreases over the course of the axial movement.

### BACKGROUND OF THE INVENTION

1. Field of the Invention

The invention relates to a drive device especially for a hatch of a motor vehicle. The drive device includes a first fastening element which can be connected to a stationary component or to a movable component; a housing tube located at the end opposite the first fastening element which is able to move axially relative to that first fastening element and has a second fastening element on the end opposite the first fastening element, it being possible to connect this second element to the other of the stationary component or the movable component; and a spindle drive which includes a threaded spindle and a spindle nut mounted on the threaded spindle, by means of which drive the first fastening element and the housing tube can be driven axially relative to each other. The spindle drive can be driven in rotation by an electric motor, the shaft of which can rotate the threaded spindle or a clutch component of a clutch.

2. Description of the Related Art

In spindle drive devices of the type mentioned above, the electric motor must be designed so that it can reliably move the component to be moved under all normal operating conditions. In the case of movable components which are relatively heavy, a correspondingly powerful electric motor must be used, the size of which will also be considerable, especially with respect to its diameter. This leads to a drive device which requires a large installation space.

### SUMMARY OF THE INVENTION

An object of the invention is therefore to create a drive device of the type indicated above which is small in size and, in particular, which has a small diameter.

This object is met according to an embodiment of the invention, by a drive having a first fastening element, a housing tube, and a threaded spindle with a spindle nut connected so that the spindle drives the first fastening element relative to the housing tube to move the first fastening element and the housing tube away from each other in the axial direction. The spindle drive can be driven in rotation at a torque which decreases over the course of this axial movement.

Because the torque demand is higher at the beginning of the movement of the first fastening element axially away from the housing tube, it is necessary to provide high torque only in this initial phase. After that, it is sufficient to apply a much lower torque.

According to one embodiment, the spindle drive is driven in rotation by a direct-current motor, where the direct-current motor, at the beginning of the movement of the first fastening element and the housing tube away from each other in the axial direction, is operated in a load range which is above the nominal load of the motor.

Because the motor operates for only a short time in the overload range, the heat generated by this overload operation is dissipated immediately, so that there is no damage to the motor. It can therefore have a lower power rating, which also means that these electric motors can have smaller diameters than motors having power ratings to meet the initial torque demand. Thus the area of the drive device occupied by the motors can have a smaller outside diameter. Because the additional parts of the drive device can easily have a small outside diameter and because the outside diameter of the drive unit is determined by the outside diameter of the motor area, the overall drive device acquires a small outside diameter.

As the first fastening element and the housing tube are moved away from each other in the axial direction, the direct-current motor can be operated in a load range above its nominal load for the first 25-50% of the distance traveled.

If an energy storage device is located in the supply line leading from the voltage source to the direct-current motor, the starting current of the motor can be stored in advance. As a result, the supply lines of the overall system can be reduced.

In a motor vehicle in which a voltage of 12 V is available from the voltage source, it is possible, for example, to double the voltage temporarily to 24 V and thus to increase the power by a factor of 4. This also means, however, that the diameter of the motor needs to be only half as large.

In one embodiment, the energy storage device is a capacitor.

The capacitor can be an electrolytic capacitor (ELCO) or an electrochemical double-layer capacitor (EDLC). An electrochemical double-layer capacitor of this type offers the advantages of having a very high capacity and of occupying only a small amount of space.

A voltage transformer is preferably installed downline from the energy storage device.

If the voltage transformer is a diode cascade transformer, two capacitors are charged cyclically in parallel and discharged in series. As a result the input voltage can be doubled.

It is also possible, however, for the voltage transformer to be a chopper/transformer type of voltage transformer, in which the input-side DC voltage is chopped into pulses and then converted by a transformer. As a result, any desired voltage levels can be realized. The output-side AC voltage is rectified and can thus be used to supply the drive unit.

Voltage can be applied to the motor preferably by way of a power output stage. The values calculated by a master control unit can be converted by pulse width-modulated relays, which are supplied directly by the voltage transformer. A pulse width-modified voltage with a mean value of 0-24 V can be set.

The torque may also be increased by designing the motor so that it can be operated either with a high-torque characteristic or with a lower-torque characteristic, and in operating it with the high-torque characteristic during the first part of the distance traveled and with the lower-torque characteristic during the following part of the distance traveled.

It is also possible, however, in another embodiment, for the spindle drive to be driven in rotation by way of a variable transmission.

The transmission can be a continuously variable transmission (CVT) or a multi-stage transmission, especially a three-stage transmission.

Optimum adaptation to the required torque is achieved when the transmission is a transmission which is controlled automatically as a function of load.

In principle, it is possible to install the electric motor outside the housing tube. If the electric motor is installed in the housing tube, however, the drive device forms a compact structural unit, where the housing tube forms simultaneously a positioning receptacle and a protective sleeve for the electric motor.

The threaded spindle can be supported rotatably at one end on the housing tube but held stationary in the axial direction with respect to the housing tube and can be driven in rotation by the electric motor, and the spindle nut connected to the first fastening element can be prevented from rotating with respect to the housing tube. This design has the result that the torque of the spindle nut is absorbed within the drive device and does not have to be supported via the fastening elements on the movable component and the stationary component.

This makes it possible to mount the drive device in any desired orientation on the movable component and the stationary component, as a result of which it becomes considerably easier to install the drive device.

The housing tube can be manufactured simply and easily by deep-drawing a metal part, for example, or by injection-molding a plastic part.

The spindle nut can be easily connected to one end of a spindle tube coaxially surrounding the threaded spindle, the first fastening element being permanently connected to the other end of the spindle tube.

The spindle tube can also be a metal part produced by a forming process such as deep-drawing, or it can be a plastic part produced by injection-molding.

If one or both of the fastening elements are designed as the ball heads or as the spherical sockets of ball joints, an embodiment is obtained which can be easily mounted in any desired rotational position with respect to the longitudinal axis of the drive device.

If, in addition to the adjusting force of the electric motor, the first fastening element is actuated or actuatable by the force of a spring in the outward-travel direction, away from the housing tube, the force of the drive device can be supported and thus the weight of the hatch balanced.

This support can extend over the entire shifting stroke or over only a part of it.

According to a simple design, the first fastening element is actuated for the purpose of this support by a compression spring, especially a helical compression spring, supported on the housing tube.

Alternatively or in addition, the first fastening element can be actuated by gas pressure.

The force which is required to move the spindle manually is preferably selected precisely so that the hatch can be held in intermediate positions when the rotary drive is turned off. Thus, in the case of a rotary drive in the form of an electric motor, a currentless stop position can be easily realized.

A guide tube which surrounds the spindle tube, leaving a certain gap, can be mounted on the housing tube.

If the helical compression spring surrounds the guide tube, leaving a certain gap, and is also surrounded, with a certain gap, by a jacket tube connected to the first fastening element, then the helical compression spring is both guided and protected radially both toward the outside and toward the inside.

The components of the drive device can be protected from dirt and damage by designing the housing tube and the jacket tube so that they can telescope into and out of each other.

So that the threaded spindle can be manually operated easily and with good efficiency, it has a multi-start thread.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are illustrated in the drawing and described in greater detail below. In the drawings:

FIG. 1 shows a cross section through a drive device according to an embodiment of the invention;

FIG. 2 shows an enlarged view of the part of the drive device marked “X” in FIG. 1; and

FIG. 3 shows a circuit diagram of the voltage supply of the motor of the drive device according to FIG. 1.

### DETAILED DESCRIPTION OF THE PRESENTLY PREFERRED EMBODIMENTS

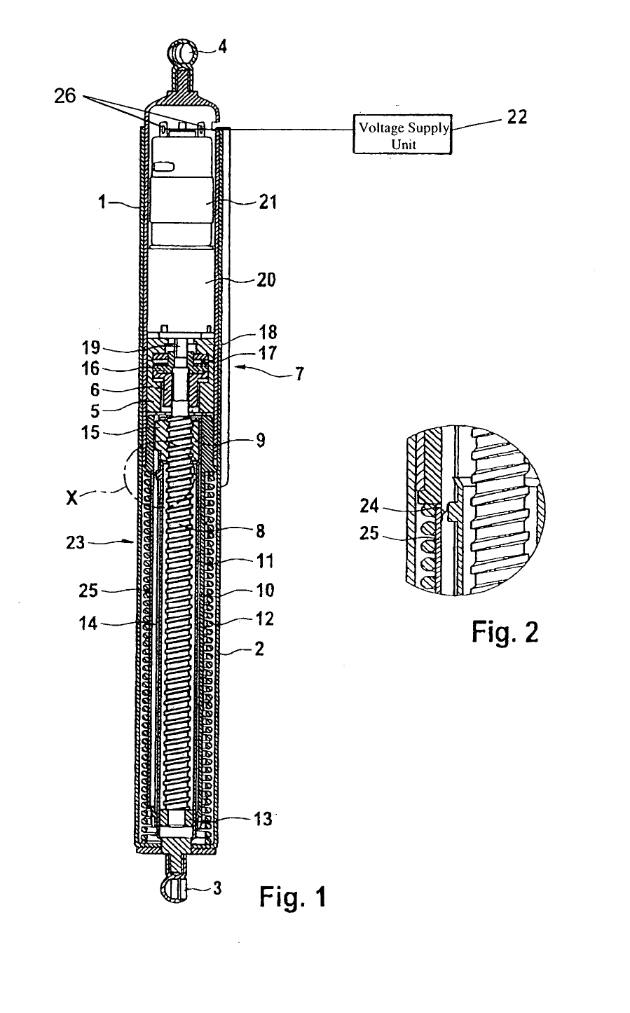

The drive device shown in FIG. 1 has a housing tube 1, on which a jacket tube 2 is guided in a telescoping manner. On the end of the jacket tube 2 opposite the housing tube 1, a first ball socket 3 is provided, and on the end of the housing tube 1 opposite the jacket tube 2, a second ball socket 4 is provided. These sockets 3, 4 make it possible to hinge the drive device to a stationary body component of a motor vehicle and to a movable component of the motor vehicle, such as a hatch. In the end area of the housing tube 1 facing the jacket tube 2, a first bearing part 5 is permanently inserted, in which a first clutch part 6 of a friction clutch 7 is rotatably supported. The clutch part 6 is seated firmly on one end of a threaded spindle 8 projecting into the jacket tube 2. A spindle nut 9 is threaded onto the threaded spindle 8 but is unable to rotate with respect to the housing tube 1.

The spindle nut 9 is connected to one end of a spindle tube 11, which coaxially surrounds the threaded spindle 8. The first ball socket 3 is permanently mounted on the other end of the spindle tube 11. The spindle nut 9 is guided with freedom to slide axially in a guide tube 10 surrounding the spindle tube 11, the guide tube 10 being permanently connected to the housing tube 1.

In the annular gap between the guide tube 10 and the jacket tube 2 surrounding it with a certain gap, a helical compression spring 12 is provided, one end of which is supported on the jacket tube 2 in the area of the first ball socket 3, the other end being supported on the housing tube 1.

At the end facing away from the first clutch part 6, the threaded spindle 8 carries a guide sleeve 13. The cylindrical lateral surface of this sleeve 13 guides the threaded spindle 8 with freedom of axial movement in the spindle tube 11.

The guide tube 10 has three axial slots 14, which are distributed uniformly around the circumference and which extend over almost its entire length. Corresponding to the axial slots 14, radially projecting support pins 15 are arranged on the spindle nut 9. These pins 15 project into the axial slots 14 and thus prevent the spindle nut 9 from turning with respect to the guide tube 10.

Coaxially opposite the first clutch part 6, a second clutch part 16 is installed in the housing tube 1. A ring-shaped friction lining can be provided between the two clutch parts 6 and 16. The side of the second clutch part 16 facing away from the first clutch part 6 is supported axially by an axial bearing 17 on an abutment part 18, which is permanently mounted in the housing tube 1.

The first clutch part 6 and the second clutch part 16 have a certain amount of play between them, so that they can move axially away from each other to break the frictional connection.

A takeoff shaft 19 of a transmission 20 is connected coaxially and nonrotatably to the second clutch part 16, where the transmission 20 can be driven in rotation by the shaft of an electric motor 21. The electric motor 21 is mounted nonrotatably in the housing tube 1.

The electric motor 21 has terminal contacts 26, which are connected to a voltage supply unit 22 so that the electric motor 21 can be supplied with voltage.

As can be seen especially in FIG. 2, the drive device has a stroke detection sensor designed as a linear potentiometer 23.

For this purpose, a wiper 24 is mounted on the spindle tube 11, near the spindle nut 9. The wiper 24 projects through one of the axial slots 14 and can be moved by the spindle nut 9 and the spindle tube 11 along a wiper track 25, which extends opposite the outer side of the axial slot 14.

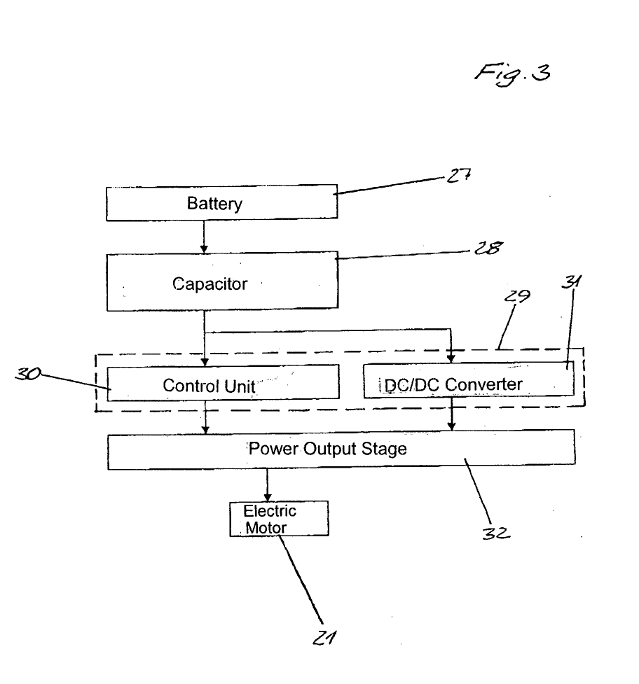

The circuit diagram of the voltage supply system shown in FIG. 3 has a battery 27, which makes available a voltage of 12 V, which is applied to a capacitor 28.

A voltage transformer unit 29 can be supplied by the capacitor 28. The unit 29 consists of a control unit 30 and a DC/DC converter 31.

The voltage transformer unit 29 can supply a power output stage 32, which in turn can supply the electric motor 21 with voltage.

The electrical energy supplied by the battery 27 to the capacitor 28 is stored in the capacitor 28 and made available to the DC/DC converter 31. The DC/DC converter 31 has the task of increasing the voltage provided by the battery 27. This higher voltage is now applied briefly by way of the control unit 30 to the electric motor 21, which then runs for a short time in its overload range.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive device for components of a motor vehicle, comprising:
a first fastening element connectable to one of a stationary component and a movable component of the motor vehicle;
a housing tube comprising a first end facing away from the first fastening element, and a second fastening element on the first end, the second fastening element being connectable to the other of a stationary component and a movable component of the motor vehicle;
a spindle drive actuatable to move the first fastening element and the housing tube away from each other in an axial movement, the spindle drive comprising:
a threaded spindle; and
a spindle nut mounted on the threaded spindle; and
an electric motor for driving the threaded spindle in rotation and effecting the axial movement, and
wherein the electric motor is configured to drive the threaded spindle in rotation with a torque which decreases over the course of the axial movement.

2. The drive device of claim 1, wherein the electric motor comprises a direct-current motor which operates in a first load range at a beginning of the axial movement and operates in a nominal load range over the remainder of the axial movement, the first load range being greater than the nominal load range.

3. The drive device of claim 2, wherein the direct-current motor operates in the first load range over approximately the first 25-50% of the axial movement.

4. The drive device of claim 2, further comprising a voltage source and an energy storage device connected between the direct-current motor and the voltage source.

5. The drive device of claim 4, wherein the energy storage device comprises a capacitor.

6. The drive device of claim 5, wherein the capacitor comprises an electrolytic capacitor.

7. The drive device of claim 5, wherein the capacitor comprises an electrochemical double-layer capacitor (EDLC).

8. The drive device of claim 4, further comprising a voltage transformer connected downline from the energy storage device.

9. The drive device of claim 8, wherein the voltage transformer comprises a diode cascade transformer.

10. The drive device of claim 8, wherein the voltage transformer comprises a chopper transformer type of voltage transformer.

11. The drive device of claim 4, further comprising a power output stage supplying voltage to the direct-current motor.

12. The drive device of claim 1, wherein the electric motor is configured so that the electric motor is operable with a higher torque characteristic at a beginning of the axial movement and with a lower torque characteristic over the remainder of the axial movement.

13. The drive device of claim 1, further comprising a variable transmission, the electric motor driving the threaded spindle in rotation through the variable transmission.

14. The drive device of claim 13, wherein the transmission comprises a continuously variable transmission.

15. The drive device of claim 13, wherein the transmission comprises a multi-stage transmission.

16. The drive device of claim 13, wherein the transmission is controllable automatically as a function of load.

17. The drive device of claim 13, wherein at least one of the electric motor and the transmission is disposed in the housing tube.

18. The drive device of claim 1, wherein one end of the threaded spindle is rotatably supported by the housing tube, the threaded spindle being axially stationary with respect to the housing tube, the spindle nut being coupled to the first fastening element and being non-rotatable with respect to the housing tube.

19. The drive device of claim 18, further comprising a spindle tube which coaxially surrounds the threaded spindle and comprises a first end connected to the spindle nut and a second end connected to the first fastening element.

20. The drive device of claim 1, wherein at least one of the first fastening element and the second fastening element comprises a ball head or a ball socket.

21. The drive device of claim 19, further comprising a spring which urges the first fastening element away from the housing tube.

22. The drive device of claim 21, wherein the spring comprises a compression spring supported on the housing tube.

23. The drive device of claim 22, further comprising a guide tube surrounding the spindle tube and creating a first predetermined gap therebetween.

24. The drive device of claim 23, further comprising a jacket tube surrounding the guide tube and creating a second predetermined gap therebetween, the compression spring being disposed in the second predetermined gap.

25. The drive device of claim 24, wherein one of the housing tube and the jacket tube telescopically slides in and out of the other of the housing tube and the jacket tube.

26. The drive device of claim 1, wherein the threaded spindle comprises a multi-thread spindle.
